(19) United States
(12) Patent Application Publication
(10) Pub. No.: US 2019/0240684 A1
(43) Pub. Date: Aug. 8, 2019

(54) WATER SPRAY GUN

(71) Applicant: Chin-Yuan Chen, Changhua (TW)

(72) Inventor: Chin-Yuan Chen, Changhua (TW)

(21) Appl. No.: 15/891,207

(22) Filed: Feb. 7, 2018

(51) Int. Cl. B05B 1/30; B05B 15/63

(52) U.S. Cl. CPC B05B 1/3026; B05B 15/63

(57) ABSTRACT

A water spray gun may comprise a main body, a water guiding base and a spray head. The main body has a handle and a barrel portion which are communicated with each other, and the handle is connected to a water source. The water guiding base is a shell body having a front opening and a water outlet channel, and a guiding channel axially penetrating through a rear portion of the water guiding base is received in the barrel portion. The guiding channel is misaligned with the water outlet channel, and a chamber having a larger diameter than the guiding channel and the water outlet channel is formed therebetween. Thus, water can be collected in the chamber before sprayed out from the water outlet channel, thereby providing a large spraying amount and area by the water spraying gun.

### FIELD OF THE INVENTION

The present invention relates to a water spray gun and more particularly to a water spray gun that can provide a large spraying amount and area.

### BACKGROUND OF THE INVENTION

Because of the large area of planting type, a water spray gun is always needed for garden works to routinely water plants. A conventional water spray gun generally has a channel formed therein, and by connecting to a water source through a tube, water can be sprayed through an opening of water spray gun to achieve watering effect.

However, the conventional water spray gun is disadvantageous because: it is deficient in having a chamber therein to collect water before spraying, and this shortcoming may result in weak water pressure or disenable the water spray gun to be used in a large area of spraying. Therefore, there remains a need for a new and improved design for a water spray gun to overcome the problems presented above.

### SUMMARY OF THE INVENTION

The present invention provides a water spray gun which comprises a main body, a water guiding base and a spray head. The main body has a handle and a barrel portion which are communicated with each other, and the handle is configured to be held by a user and to connect to a water source. Water is adapted to flow through an interior space of the handle toward the barrel portion. A connecting opening formed at a front end of the barrel portion is configured to receive and connect a rear portion of the water guiding base. The water guiding base is a shell body having a front opening and a water outlet channel, and a guiding channel axially penetrating through the rear portion of the water guiding base is received in the barrel portion of the main body. The guiding channel is misaligned with the water outlet channel, and a chamber having a larger diameter than the guiding channel and the water outlet channel is formed therebetween to form a water pathway in the water guiding base. Moreover, a sealing unit is securely disposed between a rear end of the guiding channel and a rear portion of the barrel portion. A central shaft is formed inside the water guiding base, and a front end of the shaft is adapted to protrude from the front opening. Furthermore, the shaft is configured to penetrate through the spray head and engage with a screw, thereby securing the spray head at a front end of the water guiding base.

Comparing with conventional water spray gun, the present invention is advantageous because: since the chamber is formed between the guiding channel and the water outlet channel, water can be collected in the chamber before sprayed out from the water outlet channel, thereby providing a large spraying amount and area by the water spraying gun of the present invention.

### BRIEF DESCRIPTION OF THE DRAWINGS

FIG. 1 is a three-dimensional assembly view of a water spray gun in the present invention.

FIG. 2 is a three-dimensional exploded view of the water spray gun in the present invention.

FIG. 3 is a three-dimensional view from another angle of a water guiding base of the water spray gun in the present invention.

FIG. 4 is a sectional assembly view of the water spray gun in the present invention.

FIG. 5 is a schematic view illustrating water is collected in a chamber of the water spray gun of the present invention and then sprayed out.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

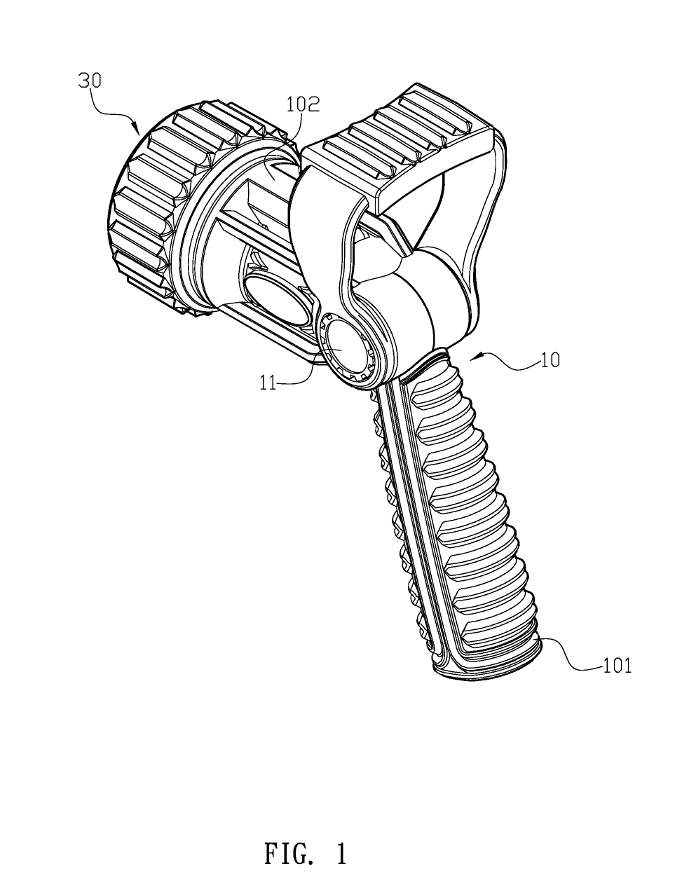

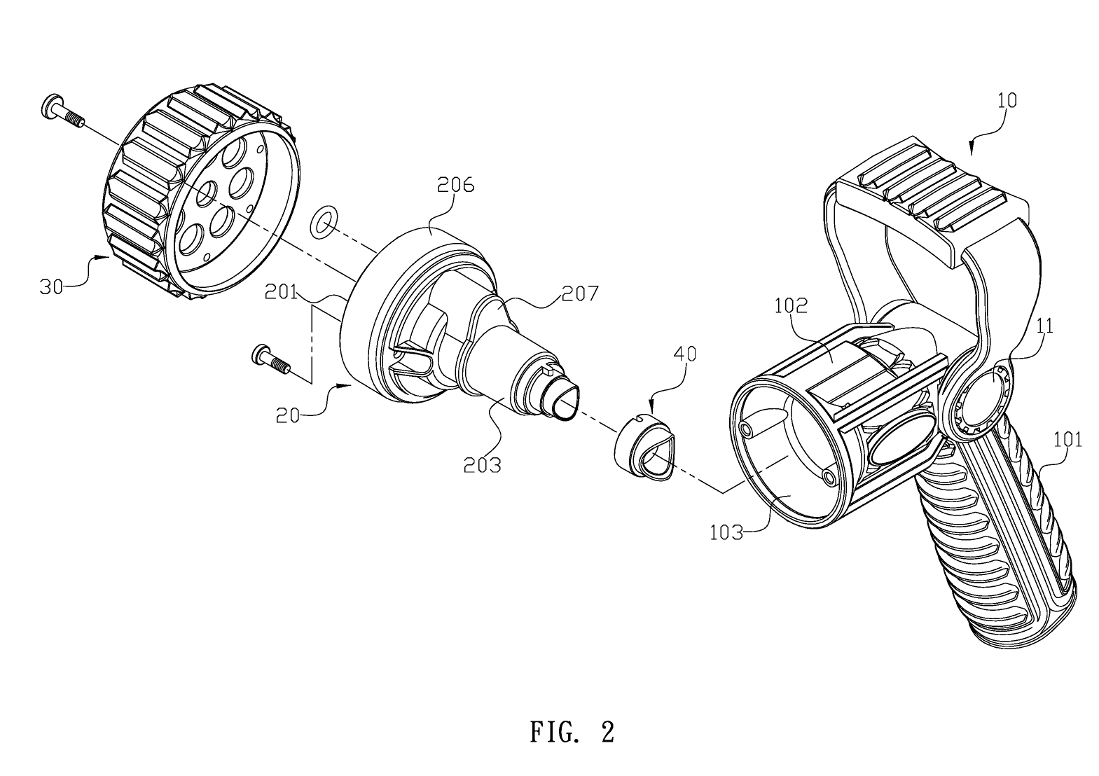

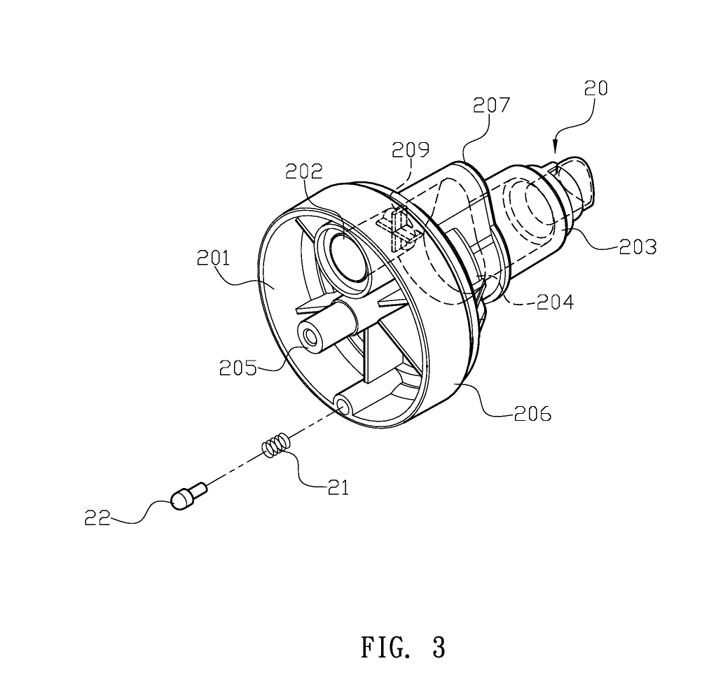

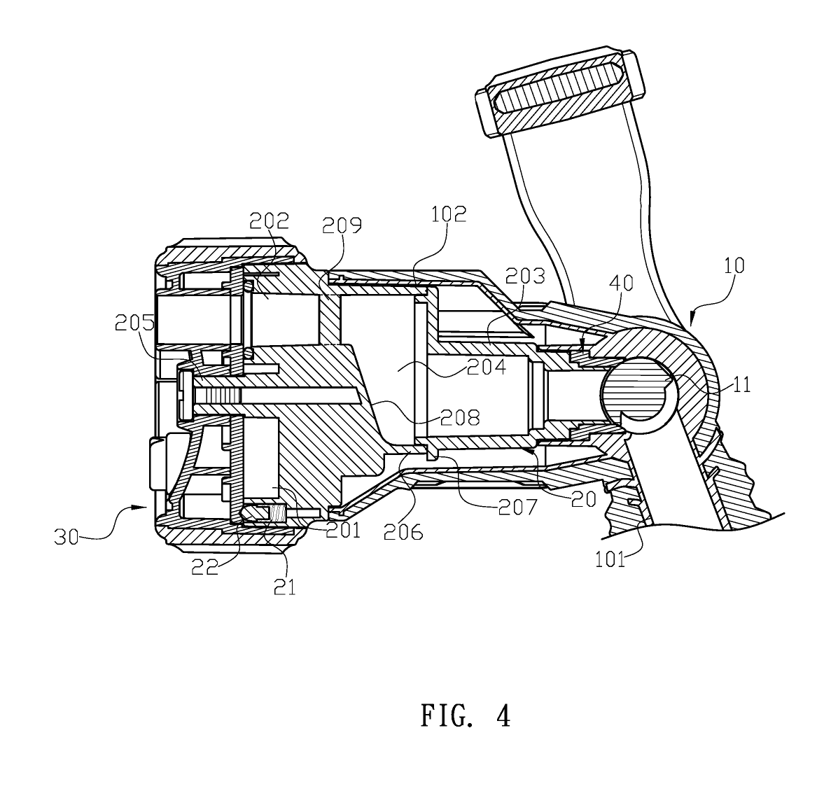

Referring to FIGS. 1 to 4, the present invention provides a water spray gun which comprises a main body (10), a water guiding base (20) and a spray head (30). The main body (10) has a handle (101) and a barrel portion (102) which are communicated with each other, and the handle (101) is configured to be held by a user and to connect to a water source. Water is adapted to flow through an interior space of the handle (101) toward the barrel portion (102). A connecting opening (103) formed at a front end of the barrel portion (102) is configured to receive and connect a rear portion of the water guiding base (20). The water guiding base (20) is a shell body having a front opening (201) and a water outlet channel (202), and a guiding channel (203) axially penetrating through the rear portion of the water guiding base (20) is received in the barrel portion (102) of the main body (10). The guiding channel (203) is misaligned with the water outlet channel (202), and a chamber (204) having a larger diameter than the guiding channel (203) and the water outlet channel (202) is formed therebetween to form a water pathway in the water guiding base (20). Moreover, a sealing unit (40) is securely disposed between a rear end of the guiding channel (203) and a rear portion of the barrel portion (102). A central shaft (205) is formed inside the water guiding base (20), and a front end of the shaft (205) is adapted to protrude from the front opening (201). Furthermore, the shaft (205) is configured to penetrate through the spray head (30) and engage with a screw, thereby securing the spray head (30) at a front end of the water guiding base (20).

In one embodiment, a water control valve (11) is formed between the handle (101) and the barrel portion (102) of the main body (10), and a user is adapted to control on/off operation of the water spray gun through pulling the water control valve (11).

In another embodiment, the water guiding base (20) is secured with the main body (10).

In still another embodiment, the water guiding base (20) comprises a front shell (206) and a rear shell (207) which are configured to fit together.

In a further embodiment, the water guiding base (20) comprises the front shell (206) and the rear shell (207) which are configured to fit together, and the chamber (204) is formed therebetween.

In still a further embodiment, the water outlet channel (202) and the guiding channel (203) are misaligned vertically.

In yet a further embodiment, an inclined guiding surface (208) formed at a front end of the chamber (204) has a gradually larger diameter from rear to front.

In a preferred embodiment, a cross-shaped partition (209) is formed inside the water outlet channel (202).

In an advantageous embodiment, a locating unit formed on the water guiding base (20) comprises a spring (21) and a locating bolt (22).

In a particular embodiment, the sealing unit (40) is a stepped hollow sleeve.

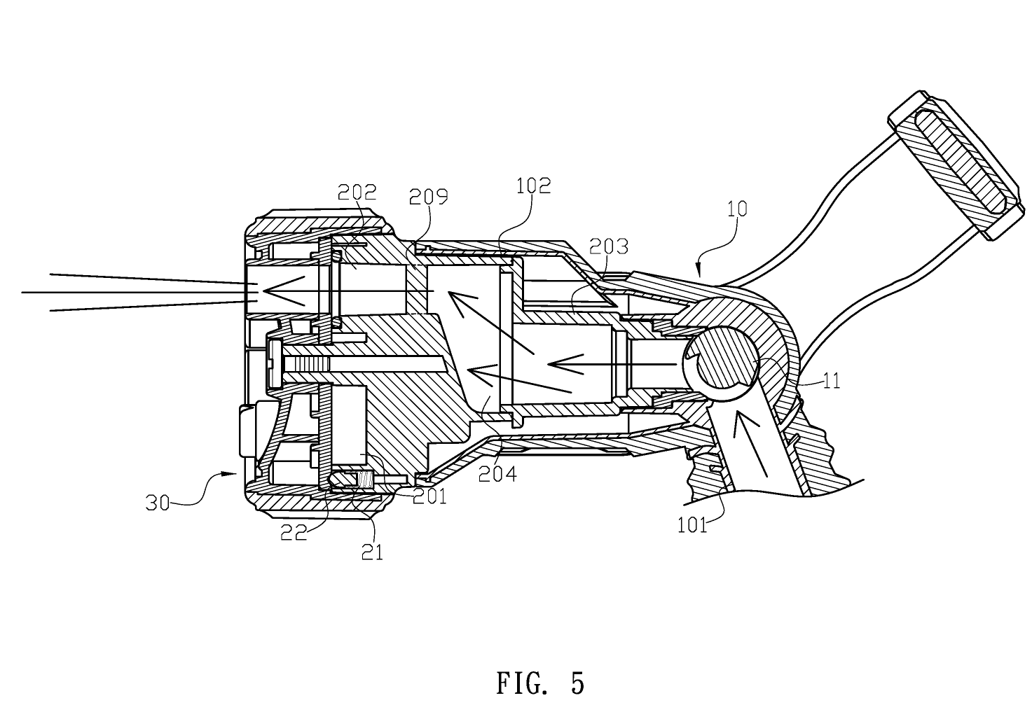

In actual application, water is configured to flow from the interior space of the handle (101) through the barrel portion (102) into the guiding channel (203), the chamber (204) and the water outlet channel (202) sequentially, and a user can hold and turn an outer periphery of the spray head (30) with different angles to spray water in different patterns. Since the chamber (204) is formed between the guiding channel (203) and the water outlet channel (202), water can be collected in the chamber (204) before sprayed out from the water outlet channel (202), thereby providing a large spraying amount and area by the water spraying gun of the present invention (as shown in FIG. 5).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water spray gun comprising a main body, a water guiding base and a spray head;
wherein the main body has a handle and a barrel portion which are communicated with each other, and the handle is configured to be held by a user and to connect to a water source; water is adapted to flow through an interior space of the handle toward the barrel portion, and a connecting opening formed at a front end of the barrel portion is configured to receive and connect the water guiding base; and
wherein the water guiding base is a shell body having a front opening and a water outlet channel, and a guiding channel axially penetrating through a rear portion of the water guiding base is received in the barrel portion of the main body; the guiding channel is misaligned with the water outlet channel, and a chamber having a larger diameter than the guiding channel and the water outlet channel is formed therebetween to form a water pathway in the water guiding base; a sealing unit is securely disposed between a rear end of the guiding channel and a rear portion of the barrel portion; a central shaft is formed inside the water guiding base, and a front end of the shaft is adapted to protrude from the front opening; and the shaft is configured to penetrate through the spray head and engage with a screw, thereby securing the spray head at a front end of the water guiding base.

2. The water spray gun of claim 1, wherein a water control valve is formed between the handle and the barrel portion of the main body.

3. The water spray gun of claim 1, wherein the water guiding base is secured with the main body.

4. The water spray gun of claim 1, wherein the water guiding base comprises a front shell and a rear shell which are configured to fit together.

5. The water spray gun of claim 1, wherein the chamber is formed between the front shell and the rear shell.

6. The water spray gun of claim 1, wherein the water outlet channel and the guiding channel are misaligned vertically.

7. The water spray gun of claim 1, wherein an inclined guiding surface is formed at a front end of the chamber.

8. The water spray gun of claim 1, wherein a cross-shaped partition is formed inside the water outlet channel.

9. The water spray gun of claim 1, wherein a locating unit formed on the water guiding base comprises a spring and a locating bolt.

10. The water spray gun of claim 1, wherein the sealing unit is a stepped hollow sleeve.
